(19) United States
(12) Patent Application Publication
(10) Pub. No.: US 2016/0227280 A1
(43) Pub. Date: Aug. 4, 2016

(54) CONTENT THAT REACTS TO VIEWERS

(71) Applicant: SONY CORPORATION, Tokyo (JP)

(72) Inventor: Brant Candelore, San Diego, CA (US)

(21) Appl. No.: 14/609,675

(22) Filed: Jan. 30, 2015

(51) Int. Cl. H04N 21/454; H04N 21/442; H04N 21/441; H04N 21/475; H04N 21/45

(52) U.S. Cl. CPC H04N 21/4542; H04N 21/4755; H04N 21/4532; H04N 21/441; H04N 21/44218

(57) ABSTRACT

Viewer demographics such as age and sex, as well as viewer emotion based on facial recognition, are sensed by a device and content automatically modified accordingly. In this way, the content essentially reacts to the types and emotions of the viewers as they watch the content.

### I. FIELD OF THE INVENTION

The application relates generally to content that reacts to viewers.

### II. BACKGROUND OF THE INVENTION

A computer ecosystem, or digital ecosystem, is an adaptive and distributed socio-technical system that is characterized by its sustainability, self-organization, and scalability. Inspired by environmental ecosystems, which consist of biotic and abiotic components that interact through nutrient cycles and energy flows, complete computer ecosystems consist of hardware, software, and services that in some cases may be provided by one company, such as Sony. The goal of each computer ecosystem is to provide consumers with everything that may be desired, at least in part services and/or software that may be exchanged via the Internet. Moreover, interconnectedness and sharing among elements of as ecosystem, such as applications within, a computing cloud, provides consumers with increased capability to organize and access data and presents itself as the future characteristic of efficient integrative ecosystems.

Two general types of computer ecosystems exist: vertical and horizontal computer ecosystems. In the vertical approach, virtually all aspects of the ecosystem are owned and controlled by one company, and are specifically designed to seamlessly interact with one another. Horizontal ecosystems, one the other hand, integrate aspects such as hardware and software that are created by other entities into one unified ecosystem. The horizontal approach allows for greater variety of input from, consumers and manufactures, increasing the capacity for novel innovations and adaptations to changing demands.

### SUMMARY OF THE INVENTION

An example ecosystem that is pertinent here is a network that provides content which can be reactive to viewers. As understood herein, with many electronic devices having both sensors such as GPS location receivers, cameras, and the like, along with processors powerful enough to intelligently exploit information from those sensors, applications executed by the processors can react to the viewers. Present principles are not simply directed to taking a census of who is watching and reporting that to service providers for advertising purposes, but rather to determining the age/sex of the viewers and evaluating their emotional involvement with the content, and then adapting content to what is being sensed about the viewers.

Accordingly, a device includes at least one computer readable storage medium having instructions executable by a processor and at least one processor configured for accessing the computer readable storage medium to execute the instructions to configure the processor for receiving an image of a person viewing a display on which content is being presented, executing face recognition on the image to establish at least one parameter of the person, and based at least in part on the parameter, automatically altering the content being presented on the display.

The parameter may include age and/or sex and/or emotion. The automatically can include altering includes substituting a less sexually and/or violently and/or or profanely graphic version of a scene of the content for a more sexually and/or violently and/or profanely graphic version of the scene. Or the opposite: the automatically altering can include substituting a more sexually and/or violently and/or or profanely graphic version of a scene of the content for a less sexually and/or violently and/or profanely graphic version of the scene.

In examples, playback of the content playback is executed using JavaScript execution and audio video decoding, and the instructions when executed by the processor configure the processor for providing the image to a JavaScript executable.

In some embodiments, the instructions when executed by the processor configure the processor for presenting on the display an indication that alternate content is available for upcoming scenes in the content. The indication can indicate an alternate level of profanity is available for at least a portion of the content and/or an alternate level of sexual graphic is available for at least a portion of the content and/or an alternate level of violence graphic is available for at least a portion of the content.

In another aspect a device includes at least one computer readable storage medium having instructions executable by a processor to configure the processor for presenting on a display a more indicator and a less indicator respectively selectable to establish user input for a more sexually and/or violently and/or profanely graphic version of the scene and a less sexually and/or Violently and/or profanely graphic version of the scene. The instructions when executed by the processor configure the processor for, based at least in past on the user input, automatically altering the content being presented on the display.

In another aspect, a method includes imaging a person viewing video content on a display, and responsive to the imaging, automatically changing at least one of: a level of profanity, a level of violence, a level of sexual activity in at least one portion of the video content.

The details of the present invention, both as to its structure and operation, can be best understood in reference to the accompanying drawings, in which like reference numerals refer to like parts, and in which:

### BRIEF DESCRIPTION OF TOE DRAWINGS

FIG. 1 is a Mock diagram of m example system including an example in accordance with present principles;

FIG. 2 is a screen shot of an example user interface (UI) to opt in to having content react to the viewer;

FIGS. 3 and 4 are flow charts of example logic according to present principles; and

FIG. 5 is a screen shot of an example content reaction type selector UI.

### DETAILED DESCRIPTION

This disclosure relates generally to computer ecosystems including aspects of consumer electronics (CE) device based user information in computer ecosystems. A system herein may include server and client components, connected over a network such that data may be exchanged between the el teat and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the internet. Or, a client and server can be connected over a local intranet or a virtual private network. A server or controller may be instantiated by a game console such as a Sony Playstation (trademarked), a personal computer, etc.

Information may be exchanged over a network between fee clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can he implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

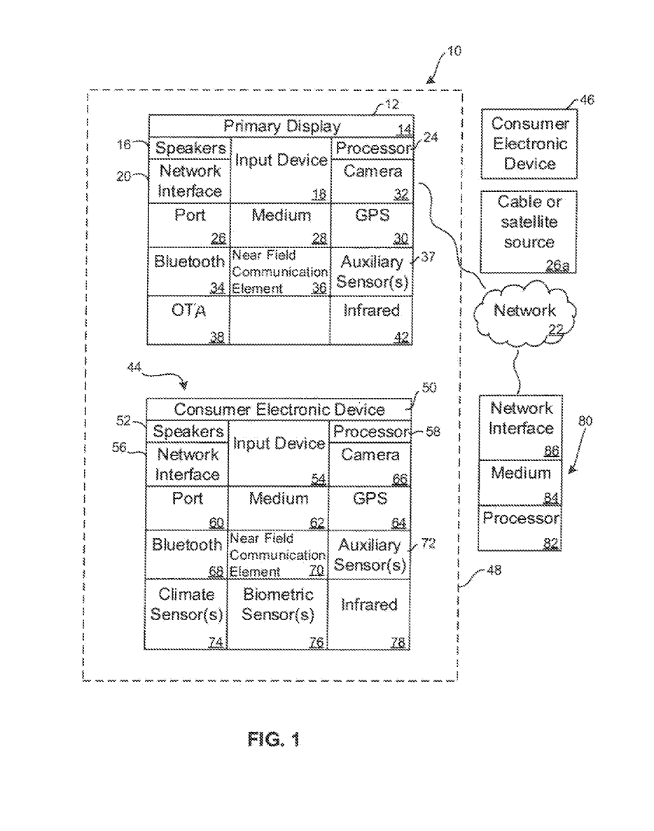

Now specifically referring to FIG. 1, an example ecosystem 10 is shown, which may include one or more of the example devices mentioned above and described further below in accordance with present principles. The first of the example devices included in the system 10 is a consumer electronics (CE) device configured as an example primary display device, and in the embodiment shown is an audio video display device (AVDD) 12 such as but not limited to an internet-enabled TV with a TV tuner (equivalently, set top box controlling a TV). However, the AVDD 12 alternatively may be an appliance or household item, e.g. computerized Internet enabled refrigerator, washer, or dryer. The AVDD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVDD 12 is configured to undertake present principles (e.g. communicate with other CE devices to undertake present principles, execute the logic described herein, and perform any other functions and/or operations described herein).

Accordingly, to undertake such principles the AVDD 12 can be established by some or all of the components shown in FIG. 1. For example, the AVDD 12 can include one or more displays 14 that may be implemented by a high definition or ultra-high definition “4K” or higher flat screen and that may be touch-enabled for receiving user input signals via touches on the display. The AVDD 12 may include one or more speakers 16 for outpacing audio in accordance with present principles, and at least one additional input device 18 such as e.g. as audio receiver/microphone for e.g. entering audible commands to the AVDD 12 to control the AVDD 12. The example AVDD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a high definition, multimedia interface (HDMI) port or a USB port to physically connect (e.g. using a wired connection) to another CE device and/or a headphone port to connect headphones to the AVDD 12 for presentation of audio from the AVDD 12 to a user through the headphones. For example, the input port 26 may be connected, via wire or wirelessly to a cable or satellite source 26a of audio video content. Thus, the source 26a may be, e.g., a separate or integrated set top box, or a satellite receiver. Or, the source 26a may be a game console or disk player containing content that might be regarded by a user as a favorite for channel assignation purposes described, further below.

The AVDD 12 may further include one or more tangible computer readable

storage medium 28 such as disk-based or solid state storage, in some cases embodied in the chassis of fee AVDD as standalone devices or as a personal video recording device (PVR) or video disk player either internal or external to the chassis of the AVDD for playing back AV programs. Also in some embodiments, the AVDD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver, GPS receiver and/or altimeter may be used in accordance with present principles to e.g. determine the location of the AVDD 12 in e.g. all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth transceiver 34 and other Near Field Communication (NFC) element for communication with other devices using Bluetooth and/or NFC technology, respectively. An example NFC element can be a radio frequency identification (RFID) element.

Further still, the AVDD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVDD 12 may include an over-the-air TV broadcast port 38 for receiving OTA TV broadcasts providing input to the processor 24. In addition to the foregoing, it is noted that the AVDD 12 may also include an infrared (IR) transmitter and/or IR receiver and/or IR transceiver 42 such as an IR data association (IRDA) device. A battery (not shown) may be provided for powering the AVDD 12.

Still referring to FIG. 1, in addition to the AVDD 12, the system 10 may include one or more other CE device types. In one example, a first CE device 44 may be used to control the display via commands sent through the below-described server while a second CE device 46 may include similar components as the first CE device 44 and hence will not be discussed in detail. In the example shown, only two CE devices 44, 46 are shown, it being understood that fewer or greater devices may be used.

In the example shown, to illustrate present principles all three devices 12, 44, 46 are assumed to be members of an entertainment network in, e.g., a home, or at least to be present in proximity to each other m a location such as a house. However, for present principles are not limited to a particular location, illustrated by dashed lines 48, unless explicitly claimed otherwise.

The example non-limiting first CE device 44 may be established by any one of the above-mentioned devices, for example, a portable wireless laptop computer or notebook computer, and accordingly may have one or more of the components described below. The second CE device 46 without limitation may be established by a video disk player such as a Blu-ray player, a game console, and the like. The first CE device 44 may be a remote control (RC) for, e.g., issuing AV play and pause commands to the AVDD 12, or it may be a more sophisticated device such as a tablet computer, a wireless telephone, etc.

Accordingly, the first CE device 44 may include one or more displays 50 that may be touch-enabled for receiving user input signals via touches on the display. The first CE device 44 may include one or snore speakers 52 for outputting audio in accordance with present principles, and at least one additional input device 54 such, as e.g. an audio receiver/microphone for e.g. entering audible commands to the first CE device 44 to control the device 44. The example first CE device 44 may also include one or more network interfaces 56 for communication over the network 22 under control of one or more CE device processors 58. Thus, the interface 56 may be, without limitation, a Wi-Fi transceiver, which is m example of a wireless computer network interface, including mesh network interfaces. It is to be understood that the processor 58 controls the first CE device 44 to undertake present principles, including the other elements of the first CE device 44 described herein such as e.g. controlling the display 50 so present images thereon and receiving input therefrom, furthermore, note the network interface 56 may be, e.g., a wired or wireless modem or router, or other appropriate interlace such as, e.g., a wireless telephony transceiver, or Wi-Fi transceiver as mentioned above, etc.

In addition to the foregoing, the first CE device 44 may also include one or more input ports 60 such as, e.g., a HDMI port or a USB port to physically connect (e.g. using a wired connection) to another CE device and/or a headphone port to connect headphones to the first CE device 44 tor presentation of audio from the first CE device 44 to a user through the headphones. The first CE device 44 may further include one or more tangible computer readable storage medium 62 such as disk-based or solid state storage. Also in some embodiments, the first CE device 44 can include a position or location, receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that that another suitable position receiver other than a cellphone and/or GPS receiver and/or altimeter may be used, in accordance with present principles to e.g. determine fee location of the first CE device 44 in e.g. all three dimensions.

Continuing the description of the first CE device 44, In some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NFC technology, respectively. An example NFC element cars be a radio frequency identification (RFID) element.

Further still, the first CB device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 42 such as an IR data association (IRDA) device. A battery (not shown) may be provided for powering the first CE device 44. The CE device 44 may communicate with the AVDD 12 through any of the above-described communication modes and related components.

The second CE device 46 may include some or all of the components shown for the CE device 44.

Now in reference to the afore-mentioned at least one server 80, it includes at least one server processor 82, at least one tangible computer readable storage medium 84 such as disk-based or solid state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server, and may include and perform “cloud” functions such that the devices of the system 10 may access a “cloud” environment via the server 80 in example embodiments. Or, the server 80 may be implemented by a game console or other computer in the same room as the other devices shown in FIG. 1 or nearby.

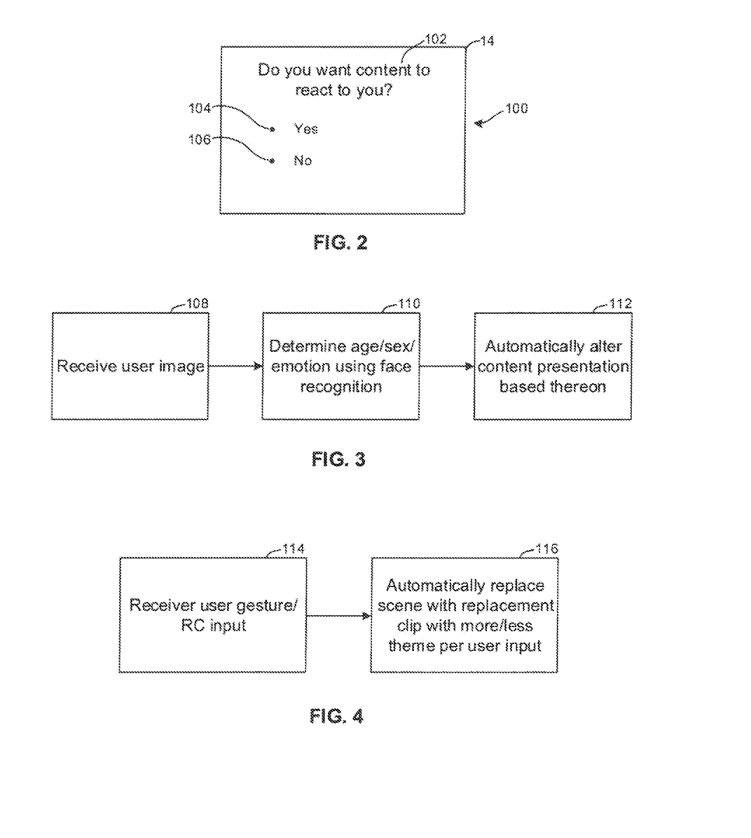

Now referring to FIG. 2, a user interface (UI) 100 may be presented on, e.g., the display 14 of the AVDD 12, prompting at 102 a user to opt hi to have content react to the user according to disclosure below by selecting an opt in selector 104. The user may opt out by selecting an opt out selector 106.

FIG. 3 illustrates example logic that may undertaken according to present principles, assuming the user opted in from the UI 100 of FIG. 2 or in embodiments in which content automatically reacts to the viewer without requiring opt-in. Commencing at block 108, an image is received of a person viewing the display 14, on which content is being presented. The image may be received from, e.g., the camera 32. Alternatively or in addition, a voice image may be received from, e.g., the microphone 18.

Proceeding to block 110 and assuming a camera image is received, the processor of the AVDD may execute a face recognition algorithm on the image to establish one or more parameters of the person. Moving to block 112, using the parameter, the content being presented on the AVDD 12 is automatically altered.

The recognized viewer attribute that establishes the parameter may be, e.g., age and/or sex and/or emotion. Examples of emotion include smiling, inferred to mean that the viewer likes what he is seeing, breathing, with shorter, taster breaths inferred to mean, e.g., excitement, squinting, which may be inferred to mean that the viewer does not like what he is viewing. Speaking as detected by the microphone or from facial recognition of the viewer, inferred to mean, e.g., ennui, and gazing away from the display, again inferred to mean, e.g., ennui.

For positive parameters indicating interest such as liking and excitement, more of the same type of content may be presented according to description below, whereas for negative parameters such as ennui and dislike, less of the same type of content may be presented. When viewer speaking is inferred, the volume of the AVDD 12 may be reduced at block 112 to make it easier to talk.

With greater specificity, at block 112 automatic content, alteration may include, e.g., substituting a less sexually and/or violently and/or or profanely graphic version of a scene of the content for a more sexually and/or violently and/or profanely graphic version of the scene currently playing. This may be done, e.g., when the viewer is recognized to be an adult and to have exhibited a negative parameter, e.g., dislike or boredom with the content. This may also be done, e.g., if the viewer is recognized as being a child, independently of whether the viewer's facial expressions indicated that the viewer liked the current scene. In other words, a parameter of “child” in this case overrides a positive parameter of “like”.

Likewise, if a viewer of a currently less sexually and/or violently and/or profanely graphic version of the scene is recognized as an adult and has evinced a positive parameter, the scene may be substituted in favor of a more sexually and/or violently and/or or profanely graphic version of a scene of the content.

Note that the content alteration at block 112 can be immediate and automatic, without farther viewer input. This may be effected by, responsive to the viewer parameter, accessing a database, winch may be stored at the server 80, e.g., of alternate versions of the same scene of a movie, with some versions being more graphic and some less, and selecting the scene according to the parameter noted above.

In one embodiment, playback/altering of the content playback can be executed using JavaScript execution and audio video decoding, and the image at block 108 may be provided to a JavaScript executable.

FIGS. 4 an 5 show that content may be altered according to user input. For instance, the AVDD processor may present on the display 14 an indication that alternate content is available for upcoming scenes in the content. At block 114 of FIG. 4, user input in reaction to the indication, may be received and block 116 content altered accordingly by, e.g., replacing a currently played scene or clip with an alternate version of that same scene or clip, except with more or less graphic detail as appropriate.

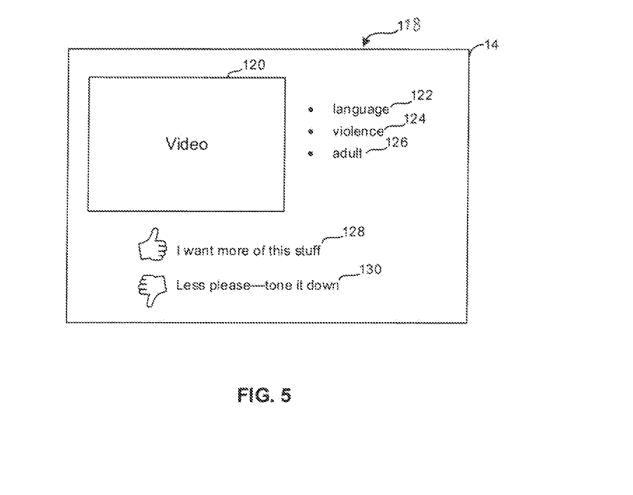

FIG. 5 illustrates with an example. A UI 118 may be presented in which the current video version is presented in a window 120. One or more indicators may be presented indicating that alternate content is available for upcoming scenes in the content. In the example shown, a profanity indicator 122 indicates an alternate level of profanity is available for at least a portion of the content. Alternatively or in addition, a violence indicator 124 can indicate that an alternate level of violence graphic is available for at least a portion of the content. Alternatively or in addition, a sex indicator 126 can indicate that an alternate level of sexual graphic is available for at least a portion of the content.

A selectable more indicator 128 (in the example shown, a thumbs-up graphic) and a selectable less indicator 130 (in the example shown, a thumbs-down graphic) may be presented. These selectors 128, 130 are respectively selectable to establish user input for a more sexually and/or violently and/or profanely graphic version of the scene and a less sexually and/or violently and/or profanely graphic version of the scene. Based at least in part on the user input, the content being presented on the display is automatically altered according to principles described above, by selecting, e.g., from a database or data stream, an alternate version of the same scene, toned down or amped up as appropriate for the user selection.

When multiple indicators 122-126 are presented, they may be selectable, so that a user may select an individual one or more for toning down or amping up the content for the specifically selected characteristic according to which more or less selector 128, 130 is toggled. No user selection may result in no content change occurring. The selections may be made by a remote control or by touching the display or by other appropriate means. The selector indicators above may be similar to those used with TV rating systems, e.g. letters.

The above methods may be implemented as software instructions executed by a processor, suitably configured application specific integrated circuits (ASIC) or field programmable gate army (FPGA) modules, or any other convenient manner as would be appreciated by those skilled in those art. Where employed, the software instructions may be embodied, in a non-transitory device such as a CD Rom or Flash drive. The software code instructions may alternatively be embodied in a transitory arrangement such as a radio or optical signal, or via a download over the internet.

It will be appreciated that whilst present principals have been described with reference to some example embodiments, these are not intended to be limiting, and that various alternative arrangements may be used to implement tire subject matter claimed herein.

1. A device comprising:
at least one computer readable storage medium having instructions executable by a processor;
at least one processor configured for accessing the computer readable storage medium to execute the instructions to configure the processor for:
receiving an image of a person viewing a display on which content is being presented;
executing image recognition on the image to establish at least first and second parameters of the person;
the first parameter including a demographic parameter correlated with a less graphic degree of content, the second parameter including a facial expression and/or gesture correlated with a more graphic degree of content, the first parameter taking precedence over the second parameter;
responsive to the first and second parameters, presenting the less graphic degree of content.

2. The device of claim 1, wherein the first parameter includes age.

3. The device of claim 1, wherein the first parameter includes sex.

4. The device of claim 1, wherein the second parameter includes emotion.

5. The device of claim 1, wherein the instructions are executable for substituting a less sexually and/or violently and/or or profanely graphic version of a scene of the content for a more sexually and/or violently and/or profanely graphic version of the scene.

6. The device of claim 1, wherein the instructions are executable for substituting a more sexually and/or violently and/or or profanely graphic version of a scene of the content for a less sexually and/or violently and/or profanely graphic version of the scene.

7. The device of claim 1, wherein playback of the content playback is executed using JavaScript execution and audio video decoding, and the instructions are executable for providing the image to a JavaScript executable.

8. (canceled)

9. A device comprising:
at least one computer storage that is not a transitory signal and that comprises instructions executable by at least one processor for;
receiving at least one image of at least one viewer of a display presenting content;
executing image recognition on the at least one image;
responsive to a determination the at least one image correlates to a first breathing threshold,
automatically altering the content being presented on the display.

10. The device of claim 9, wherein the automatically altering includes substituting a less sexually and/or violently and/or or profanely graphic version of a scene of the content for a more sexually and/or violently and/or profanely graphic version of the scene.

11. The device of claim 9, wherein the automatically altering includes substituting a more sexually and/or violently and/or or profanely graphic version of a scene of the content for a less sexually and/or violently and/or profanely graphic version of the scene.

12. The device of claim 9, wherein the instructions are executable for:
presenting on a display a more indicator and a less indicator respectively selectable to establish user input for a more sexually and/or violently and/or profanely graphic version of the scene and a less sexually and/or violently and/or profanely graphic version of the scene; and
presenting on the display an indication that alternate content is available for upcoming scenes in the content.

13. The device of claim 9, comprising the at least one processor.

14. The device of claim 12, wherein the indication indicates an alternate level of profanity is available for at least a portion of the content.

15. The device of claim 12, wherein the indication indicates an alternate level of sexual graphic is available for at least a portion of the content.

16. The device of claim 12, wherein the indication indicates an alternate level of violence graphic is available for at least a portion of the content.

17. The device of claim 21, wherein the indication indicates an alternate level of profanity is available for at least a portion of the content.

18. The device of claim 21, wherein the indication indicates an alternate level of sexual graphic is available for at least a portion of the content.

19. The device of claim 21, wherein the indication indicates an alternate level of violence graphic is available for at least a portion of the content.

20. Method comprising:
presenting video content on a display;
receiving at least one image of at least one viewer of a display presenting video content;
executing image recognition on the at least one image;
responsive to a determination that the at least one image correlates to speaking automatically altering the video content being presented on the display.

21. The device of claim 1, wherein the instructions are executable for:
presenting on the display an indication that alternate content is available for upcoming scenes in the content.
